(19) United States
(12) Patent Application Publication
(10) Pub. No.: US 2009/0199365 A1
(43) Pub. Date: Aug. 13, 2009

(54) STEPPED PIN ASSEMBLY FOR AN AXLE AND METHOD THEREFOR

(76) Inventors: Roger Svensson, Sedona, AZ (US); Anders Carlsson, Atvidaberg (SE); Everth Svensson, Atvidaberg (SE)

Correspondence Address: WEISS & MOY PC, 4204 NORTH BROWN AVENUE, SCOTTSDALE, AZ, 85251, US

(21) Appl. No.: 12/029,238

(22) Filed: Feb. 11, 2008

(51) Int. Cl. E05D 5/12; E05D 5/10; F16B 13/06; F16B 35/00; F16B 37/00; F16B 43/00; B21K 13/02

(52) U.S. Cl. 16/386; 411/531; 411/15; 411/427; 411/378; 29/11

(57) ABSTRACT

A pin assembly for providing a stable anchor on multiple ends has an axle having a pair of end members formed on each end of the axle. The axle is placed in a first opening in a first mounting end of a component part and extends to a second opening in a second mounting end of the component part. A bearing is mounted on a central section of the axle. A spacer is positioned between the bearing and one of the first or second mounting ends. A pair of expansion sleeves is provided wherein one of the pair of expansion sleeves is positioned over each of the end members of the axle. A pair of locking devices is provided wherein one of the pair of locking devices is coupled to each of the end members. When tightened, the locking devices cause the expansion sleeves to press against interior walls of the first and second openings to anchor the axle.

### FIELD OF THE INVENTION

This invention relates generally to an arrangement for an axle which is anchored at two points situated at the ends of the axle and, more specifically, to an arrangement for an axle for a bearing-mounted hinge by means of which very stable fixing of the inner race of the bearing can be obtained.

### BACKGROUND OF THE INVENTION

The conventional way to achieve pivotability in a connection between two machine parts is to use a hinge journalled in bearings, comprising one or more bearings arranged on an axle which is fixed in between a pair of mounting cheeks or the like on one of the machine parts. The inner race of the bearing or bearings is disposed on the axle and, possibly with the aid of distancing rings, bridges the distance between the fixing cheeks, while the outer race of the bearing or bearings is effectively connected to the second machine part. Since relative movement between the inner bearing race and the axle produces progressively increasing wear resulting in excessive play and perhaps fracture of the axle, the race has to be fixed relative to the axle by means of nuts screwed onto the respective axle ends. It is important that the nuts are tightened just the right amount, since excessive tightening may jeopardize the attachment of the mounting cheeks, and excessive play may arise as a result of insufficient tightening, with the results mentioned above

Therefore, a need existed to provide a system and method to overcome the above problem. The system and method would provide an arrangement for an axle for a bearing-mounted hinge by means of which very stable fixing of the inner race of the bearing can be obtained, thereby preventing the disadvantages described above.

### SUMMARY OF THE INVENTION

A pin assembly for providing a stable anchor on multiple ends has an axle having a pair of end members formed on each end of the axle. The axle is placed in a first opening in a first mounting end of a component part and extends to a second opening in a second mounting end of the component part. A bearing is mounted on a central section of the axle. A spacer is positioned between the bearing and one of the first or second mounting ends. A pair of expansion sleeves is provided wherein one of the pair of expansion sleeves is positioned over each of the end members of the axle. A pair of locking devices is provided wherein one of the pair of locking devices is coupled to each of the end members. When tightened, the locking devices cause the expansion sleeves to press against interior walls of the first and second openings to anchor the axle

A method of installing a pin assembly for providing a stable anchor on multiple ends comprises: providing a pin assembly comprising: an axle having a first and second end members formed on the axle; a bearing mounted on a central section of the axle; a spacer; a pair of expansion sleeves, wherein one of the pair of expansion sleeves is positioned over each of the end members of the axle; and a pair of locking devices; positioning the spacer between the bearing and one of the first or second mounting ends; positioning the axle so that the axle is placed in a first opening in a first mounting end of a component part and extends to a second opening in a second mounting end of the component part, the axle passing through the bearing and the spacer element and through the second opening; attaching one of the pair of fastening element to the second end member to eliminate axial play; placing one of the pair of expansion sleeves over the first end member of the axle; and attaching a second of the pair of fastening elements to the first end member and tightening so that the one of the pair of expansion sleeves expands and press against an interior wall of the first opening.

The present invention is best understood by reference to the following detailed description when read in conjunction with the accompanying drawings.

### BRIEF DESCRIPTION OF THE DRAWINGS

FIG. 1 is a perspective view of the stepped pin assembly used to connect two machine parts;

FIG. 2 is an exploded view of the stepped pin assembly; and

FIG. 3A-3D shows a method of installing the stepped pin of the present invention.

Common reference numerals are used throughout the drawings and detailed description to indicate like elements.

### DETAILED DESCRIPTION

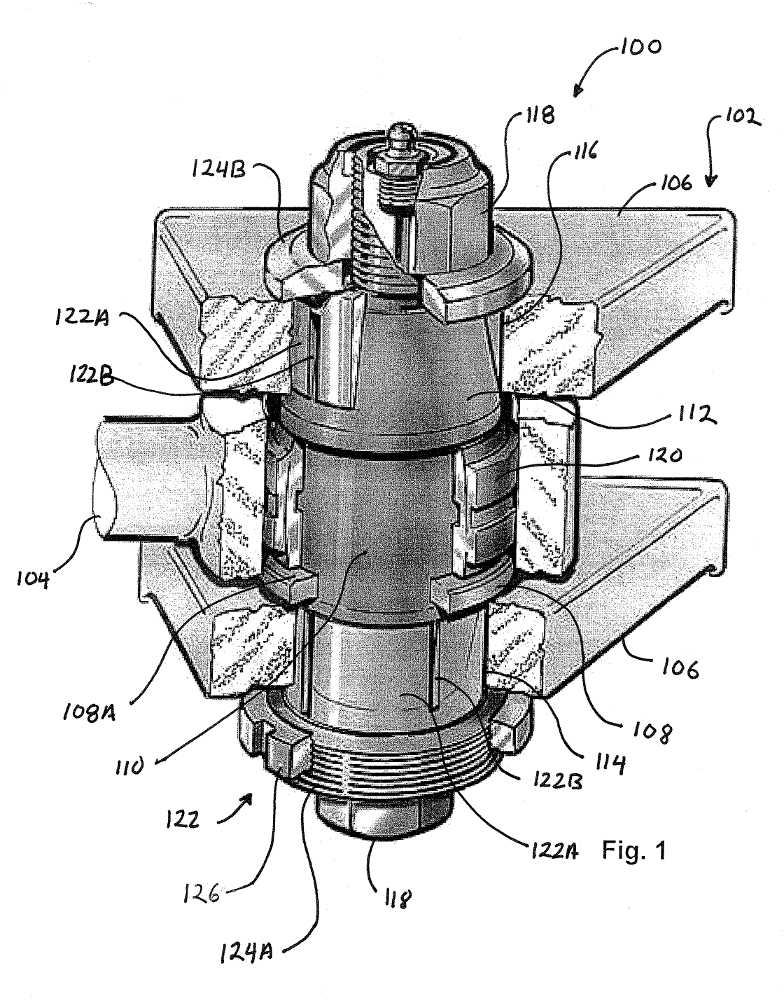

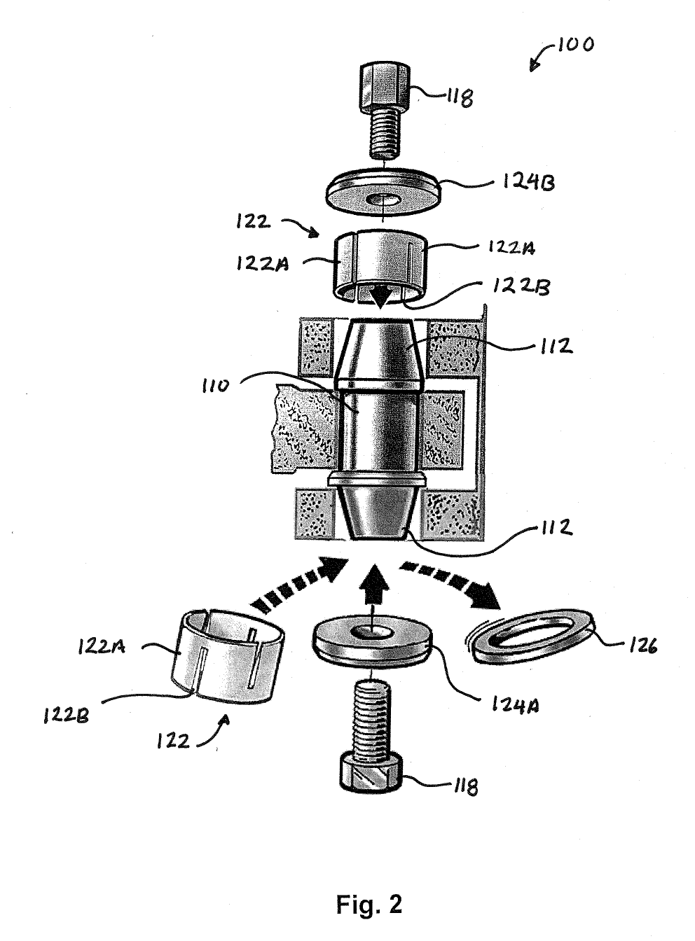

The present invention provides an arrangement for an axle for a bearing-mounted hinge for which a very stable fixing of the inner race of the bearing can be obtained. Referring to FIGS. 1 and 2, a stepped pin assembly 100 is shown. The stepped pin assembly 100 is used to pivotally couple two component parts 102 and 104 of a machine together. In the embodiment shown in FIGS. 1 and 2, the stepped pin assembly 100 is positioned between two mounting cheeks 106 of the component part 102. A spacer element 108 is generally positioned between the lower component part 104 and the mounting cheeks 106.

The pin assembly 102 will have an axle 110. A pair of end members 112 is formed on each end of the axle 110. In the embodiment shown in FIGS. 1 and 2, the end members 112 are tapered so that the distal end of the end members 112 is narrower than the proximal end. However, this is just shown as an example. The end members may be cylindrical in shape as will be discussed below.

The axle 110 is passed through through-bores 114 and 116 formed in the mounting cheeks 106 and fixed relative to them by means of a pair of fastening devices 118 coupled to each end member 112. In the embodiment depicted in FIGS. 1 and 2, each end member has a threaded channel formed down a portion of the length of the end member 112. The fastening elements 118 are rotateably coupled to each end member 112 of the pin assembly 102 outside of the mounting cheeks 106. On a central section of the axle 110 is bearing 120 is mounted. The space between the bearing 120 and the mounting cheeks 106 is bridged by the spacer element 108.

In the embodiment depicted in FIGS. 1 and 2, a pair of expansion sleeves 122 is inserted in the through-bores 114 and 116. Each expansion sleeve 122 has a housing 122A. In accordance with one embodiment of the present invention, the housing 122A is cylindrical in shape while the end member 112 of the pin assembly 102 is conical. However, in accordance with another embodiment of the present invention, the housing 122A is conical in shape while the end member 112 of the pin assembly 102 is cylindrical.

Each housing 122A is hollow and has a pair of open ends. A plurality of slots 122B is formed in the housing 122A and goes through the housing 120 into the hollow section of the housing 122A. The slots 122B generally run along a length of the housing 122A. At least one of the plurality of slots 122B will run an entire length of the housing 122A. The slots 122B act as annular wedges, with the apex pointing towards the central section of the axle 110. The number of slots 122B formed in the housing 122 is based on the diameter of the housing 122. The larger the diameter of the housing 122 the more slots 122B are generally needed. In general, four to six slots 122B are formed in each housing 122. The slots 122B will run vertically down the side of the housing 122. One slot 122B may run the length of the housing 122. The housing 122 is generally made of a sturdy metallic material. In accordance with one embodiment of the present invention, a treated yellow chrome oxide is used to form the housing 122.

The expansion sleeves 122 are used for anchoring of the axle 110 in the respective mounting cheeks 106. This is accomplished by causing the respective expansion sleeves 122 to expand over the end members 112 of the axle 110 by means of the fastening elements 118 and a pair of washer elements 124A and 124B so that the expansion sleeves 122 are pressed against the interior walls of the through-bores 114 and 116 respectively. When the fastening element 118 is tightened, the spacer element 108 presses the inner race of the bearing 120. The slots 122B allow the expansion sleeves 122 to expand and press against the interior walls of the through-bores 116 thus securing the inner race to be fixed properly without risk of deformation. In accordance with one embodiment of the present invention, the fastening elements 118 are a pair of locking screws rotateably coupled to the end members 112 of the axle 110. Each locking screw would engage the threaded channel formed down a portion of the length of each of the end member 112.

After the fastening element 118 is tightened to a proper level, a lock nut 126 is attached. The lock nut 126 is used to further secure the pin assembly 102 in position and eliminate any possibility of axial movement. In accordance with one embodiment of the present invention, a threaded washer 124A and a torque lock nut 126 is used. The torque lock nut 126 will engage threads formed on the threaded washer 124A. By tightening the torque lock nut 126 onto the threaded washer 124A, this will further secure the pin assembly 102 in position and eliminate any possibility of axial movement.

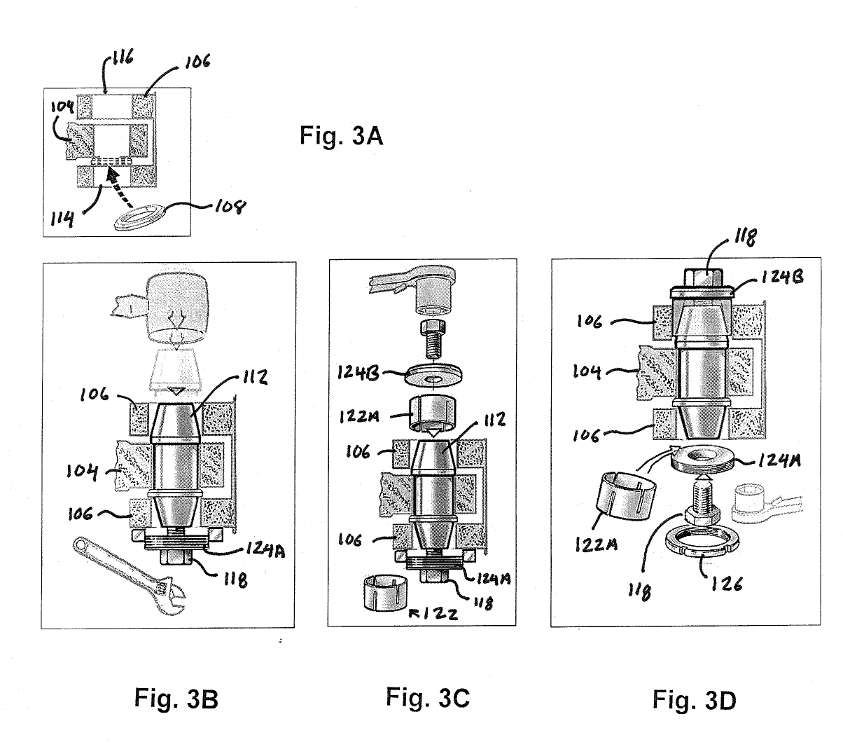

Referring to FIGS. 3A-3D, a method of installing the stepped pin assembly 100 will be disclosed. As shown in FIG. 3A, two component parts 102 and 104 need to be coupled together with the stepped pin assembly 100. In the embodiment shown in FIG. 3A, a component part 104 is positioned between two mounting cheeks 114 and 116. A spacer element 108 should be positioned between the component part 104 and the lower mounting cheek 106. The spacer element 108 should be positioned between the component part 104 and the lower mounting cheek 106 so that a bevel side 108A is facing the bearing 120 on the axle 110 when the stepped pin assembly 100 is installed.

As shown in FIG. 3B, the axle 110 of the stepped pin assembly 100 is passed through the through-bores 114 and 116 in the mounting cheeks 106. After the axle 110 has been passed through the through-bore 116, the bearing 120 and the spacer element 108 in that order are threaded over the axle 110, after which the axle 110 is passed through the through-bore 114 so that it is finally located outside the lower mounting cheek 106. It will be appreciated that one prerequisite for the axle 110 being able to be pushed through the through bore 114 is that the inner diameter of the fixed spacer element 108 should be less than the diameter of the through-bore 116. A fastening element 118, a threaded washer element 124A, and the torque lock nut 126 are then rotateably coupled to the lower end member 112 of the pin assembly 102 outside of the mounting cheek 106 to eliminate any axial play.

An expansion sleeve 122 is first placed over an upper end member 112 of the axle 110. One of the fastening elements 118 and the washer elements 124B is rotateably coupled to the upper end member 112 and tightened. The expansion sleeve 122 has an internal diameter such that the expansion sleeve 122 is not influenced when the fastening element 118 is tightened. When the fastening element 118 is tightened, the spacer element 108 presses the inner race of the bearing 120. The slots 122B allow the expansion sleeves 122 to expand and press against the interior walls of the through-bores 116 thus securing the inner race to be fixed properly without risk of deformation. In order to achieve secure mounting of the axle 110 relative to the mounting cheeks 102, the expansion sleeve 122 is first put on the axle end which is situated furthest away from the spacer element 108 which is rigidly fixed on the axle 10.

As shown in FIG. 3D, an expansion sleeve 122 then needs to be placed over the lower end member 112 of the axle 110. The fastening element 118 and the washer element 124A are then rotateably removed from the lower end member 112 of the pin assembly 102. An expansion sleeve 122 is then placed over the lower end member 112 of the axle 110. The fastening element 118 and the washer elements 124A are then again rotateably coupled to the lower end member 112 and tightened. The slots 122B allow the expansion sleeves 122 to expand and press against the interior walls of the through-bores 114 thus securing the inner race to be fixed properly without risk of deformation.

The pin assembly 102 provides for an arrangement for an axle 110 which is anchored at two points situated at the end 112 of the axle 110, generally in mounting cheeks 106 or the like provided with through-bores 114 and 116 for the axle 110. Anchoring is accomplished by means of fastening elements 118 which can be rotateably coupled on outside the fixing points. On a central cylindrical part of the axle 110 is designed to have a bearing 120 mounted thereon which is fixed by means of a spacer element 108 disposed on the axle 110 and bridging the distance between the respective fixing points and the bearing 120. Two expanding sleeves 122 can be inserted in the through-bores 114 and 116 over the respective fixing points onto the ends 112 of the axle 110. The expansion sleeves 122 act as annular wedges with their apex pointing towards the cylindrical part of the axle 110 so that by means of the fastening elements 118 the respective expansion sleeves 122 can be caused to expand against or be pressed in by the wall of the through-bores 114 and 116 thereby accomplishing the anchoring of the axle 110.

After the fastening element 118 is tightened to a proper level, a lock nut 126 is attached. The lock nut 126 is used to further secure the pin assembly 102 in position and eliminate any possibility of axial movement. In accordance with one embodiment of the present invention, a threaded washer 124A and a torque lock nut 126 is used. The torque lock nut 126 will engage threads formed on the threaded washer 124A. By tightening the threaded torque lock nut 126 onto the washer 124A, this will further secure the pin assembly 102 in position and eliminate any possibility of axial movement.

This disclosure provides exemplary embodiments of the present invention. The scope of the present invention is not limited by these exemplary embodiments. Numerous variations, whether explicitly provided for by the specification or implied by the specification, such as variations in structure, dimension, type of material and manufacturing process may be implemented by one of skill in the art in view of this disclosure.

What is claimed is:

1. A pin assembly for providing a stable anchor on multiple ends comprising:
an axle having a pair of end members formed on each end of the axle, the axle placed in first opening in a first mounting end of a component part and extends to a second opening in a second mounting end of the component part;
a bearing mounted on a central section of the axle;
a spacer positioned between the bearing and one of the first or second mounting ends;
a pair of expansion sleeves, wherein one of the pair of expansion sleeves is positioned over each of the end members of the axle; and
a pair of locking devices, wherein one of the pair of locking devices is coupled to each of the end members, the locking devices causing expansion sleeves to press against interior walls of the first and second openings to anchor the axle.

2. A pin assembly for providing a stable anchor on multiple ends in accordance with claim 1 further comprising:
a first washer placed between the first mounting end of the component part and one of the pair of locking devices;
a second washer placed between the second mounting end of the component part and one of the pair of locking devices.

3. A pin assembly for providing a stable anchor on multiple ends in accordance with claim 1 wherein the pair of end members are tapered so that a distal end of each end member is narrower than a proximal end of each end member.

4. A pin assembly for providing a stable anchor on multiple ends in accordance with claim 3 wherein each of the pair of expansion sleeves are cylindrical in shape.

5. A pin assembly for providing a stable anchor on multiple ends in accordance with claim 1 each of the pair of expansion sleeves comprises:
a housing having a hollow interior and pair of open ends; and
a plurality of slots running along a length of the housing;

6. A pin assembly for providing a stable anchor on multiple ends in accordance with claim 5 wherein the plurality of slots extend through the housing into the hollow interior.

7. A pin assembly for providing a stable anchor on multiple ends in accordance with claim 5 wherein at least one of the plurality of slots runs an entire length of housing and into the hollow interior.

8. A pin assembly for providing a stable anchor on multiple ends in accordance with claim 1 wherein the spacer is positioned between the bearing and one of the first or second mounting ends so that a bevel side of the spacer is facing the bearing.

9. A pin assembly for providing a stable anchor on multiple ends in accordance with claim 1 wherein each of the pair of locking devices comprises a locking screw rotateably coupled to each of the end members.

10. A pin assembly for providing a stable anchor on multiple ends in accordance with claim 1 further comprising a locking nut secured to the coupled to the second washer to further secure the pin assembly in position and eliminate axial movement.

11. A pin assembly for providing a stable anchor on multiple ends comprising:
an axle having a pair of end members formed on each end of the axle, the axle placed in a first opening in a first mounting end of a component part and extends to a second opening in a second mounting end of the component part;
a bearing mounted on a central section of the axle;
a spacer positioned between the bearing and one of the first or second mounting ends so that a bevel side of the spacer is facing the bearing;
a pair of expansion sleeves, wherein one of the pair of expansion sleeves is positioned over each of the end members of the axle;
a pair of locking devices, wherein one of the pair of locking devices is coupled to each of the end members, the locking devices causing expansion sleeves to press against interior walls of the first and second openings to anchor the axle;
a first washer placed between the first mounting end of the component part and one of the pair of locking devices; and
a second washer placed between the second mounting end of the component part and one of the pair of locking devices;
wherein the pair of end members are tapered so that a distal end of each end member is narrower than a proximal end of each end member.

12. A pin assembly for providing a stable anchor on multiple ends in accordance with claim 11 wherein each of the pair of expansion sleeves are cylindrical in shape.

13. A pin assembly for providing a stable anchor on multiple ends in accordance with claim 11 each of the pair of expansion sleeves comprises:
a housing having a hollow interior and pair of open ends; and
a plurality of slots running along a length of the housing;

14. A pin assembly for providing a stable anchor on multiple ends in accordance with claim 13 wherein the plurality of slots extend through the housing into the hollow interior.

15. A pin assembly for providing a stable anchor on multiple ends in accordance with claim 13 wherein at least one of the plurality of slots runs an entire length of housing and into the hollow interior.

16. A pin assembly for providing a stable anchor on multiple ends in accordance with claim 11 wherein each of the pair of locking devices comprises a locking screw rotateably coupled to each of the end members.

17. A pin assembly for providing a stable anchor on multiple ends in accordance with claim 11 further comprising a locking nut secured to the coupled to the second washer to further secure the pin assembly in position and eliminate axial movement.

18. A method of installing a pin assembly for providing a stable anchor on multiple ends comprising:
providing a pin assembly comprising:
an axle having a first and second end members formed on the axle;
a bearing mounted on a central section of the axle;
a spacer;
a pair of expansion sleeves, wherein one of the pair of expansion sleeves is positioned over each of the end members of the axle; and
a pair of locking devices;
positioning the spacer between the bearing and one of the first or second mounting ends;
positioning the axle so that the axle is placed in a first opening in a first mounting end of a component part and extends to a second opening in a second mounting end of the component part, the axle passing through the bearing and the spacer element and through the second opening;
attaching one of the pair of fastening element to the second end member to eliminate axial play;
placing one of the pair of expansion sleeves over the first end member of the axle; and
attaching a second of the pair of fastening elements to the first end member and tightening so that the one of the pair of expansion sleeves expands and press against an interior wall of the first opening.

19. The method of claim 18 further comprising:
removing the one of the pair of fastening element from the second end member;
placing a second of the pair of expansion sleeves over the second end member of the axle; and
attaching the one of the pair of fastening elements to the second end member and tightening so that the second of the pair of expansion sleeves expands and press against an interior wall of the second opening.

20. The method of claim 18 further comprising:
positioning a first washer between the first mounting end of the component part and the second of the pair of locking devices;
positioning a second washers between the second mounting end of the component part and the one of the pair of locking devices.
